(19) United States
(12) Patent Application Publication
(10) Pub. No.: US 2003/0198347 A1
(43) Pub. Date: Oct. 23, 2003

(54) System for handling digital rights and keys in business-to-business applications, computer software program, computer software modules and software products therefore

(75) Inventors: Joan-Maria Mas Ribes, Bruxelles (BE); Xavier Orri Sainz de Los Terreros, Louvain-Ia-Neuve (BE); Xavier Verians, Wavre (BE)

Correspondence Address: REED SMITH LLP, Suite 1400, 3110 Fairview Park Drive, Falls Church, VA, 22042, US

(73) Assignee: Octalis SA

(21) Appl. No.: 10/126,692

(22) Filed: Apr. 22, 2002

(51) Int. Cl. H04L 9/00; G06F 17/60

(52) U.S. Cl. 380/277; 705/51

(57) ABSTRACT

There is provided a conditional access system for the distribution and management of digital rights and keys in business-to-business applications of a plurality of actors including rights owners and rights consumers. The logical path between the rights owner and the rights consumer is decomposed into a succession of point-to-point communications between actors or groups of actors and by sharing information that allows identifying actors or groups of actors and establishing secure communications between these actors or groups of actors. Keys communication channels and digital rights communication channels are matched with a network of business relations defining a network of trust between the different actors. The conditional access system of the invention for the distribution and management of digital rights and keys is adapted to be used in a digital cinema network comprising keys communication channels and digital rights communication channels. A computer program for running the system and software or hardware modules and products for this purpose are also provided.

### BACKGROUND OF THE INVENTION

This invention relates system for handling digital rights and keys in business-to-business applications, computer software program, computer software modules, software products and hardware products therefore, and in particular to a new architecture and management model and more specifically to a system for the distribution and management of digital rights and keys in business-to-business applications.

Any type of valuable content (audio, video, text, metadata, etc.) needs to be protected whenever it is sent through an insecure communication channel. Typically this is achieved by means of an encryption process of the content; but then, what needs to be protected is the content decryption key. However, simply protecting the content decryption key is not enough: one also wants/needs to attach to that key a set of usage rights and constraints that describe under which circumstances and for what purpose that key can be used. This is called “Digital Rights Management” (DRM) in the Internet world, or “Conditional Access System” (CAS) in the digital TV world.

Today's practice in DRM systems and CAS rely on a centralized infrastructure under the control of a sole entity with which content providers, service providers and content consumers communicate in order to define and manage content usage rights and provide content decryption keys to authorized consumers. This approach works fine in a business-to-consumer market in which there is the need for centrally controlling who has access to what and under which circumstances. However, the centralized nature of today's DRM systems proves inadequate in a business-to-business market in general, and Digital Cinema specially. In the cinema industry for example, a studio or distributor rarely knows directly all the individual projectors installed on an exhibition site. Moreover, movie rights are today negotiated through an ensemble of intermediaries acting on behalf of the rights owner.

A classical DRM system would need to know (that is, know how to securely send content decryption keys and digital rights) each individual rights consumer (a projector for example) throughout the world, or at least, every exhibition site worldwide, not to mention all rights owners (studios) and intermediaries in the rights negotiation (distribution chains worldwide). Although such a system could work, it has some important drawbacks: lack of flexibility and scalability.

Flexibility is limited by the fact that the central entity controlling the system needs to know the parameters of every single actor in the system, from rights owners down to rights consumers. The centralized entity acts as gatekeeper and thus, any action regarding user management, authorizations and policy definitions, rights definition or sending of digital rights and decryption keys has to go through it. In the digital cinema case, for example, the inclusion of any entity in the system, be it a theater that has gone digital or a single projector, requires the validation and approval by the central entity. Moreover, it is not possible for a theatre manager to replace a malfunctioning projector and project a title without communicating with the central entity and the consequent validation and approval. From a responsibility point of view, the above-described approach requires a company or authority managing the system. This is always an issue in business-to-business applications because the entity controlling the system needs to be neutral. In digital cinema this is even more dramatic because the distribution chain takes place at international levels.

Scalability is also reduced in such a system. First the topology cannot be modified. Content owners and consumers have to communicate rights through the central entity. The addition or removal of an actor in the system requires the agreement of the central entity. The complexity of the system management increases with the number of actors. In Digital Cinema, the number of actors (studio, distributors, theatres, projectors, intermediaries) is large and can change everyday.

The digital cinema marked is an example for the above situation. The motion picture industry is undergoing a thorough change due to the advent of the movie digitalization. Several demonstrations throughout the world have shown that the technology is mature to implement end-to-end digital cinema systems. They have validated the use of digital movie servers, digital projectors, digital movie transmission through satellites or fiber networks, efficient compression algorithms and strong encryption algorithms. Among the last technologies that remain to be demonstrated is the conditional access system which will take in charge the projection rights management.

A conditional access system is much more than movie encryption or decryption. It also needs to manage all the projection rights that are exchanged between distributors and exhibitors. In other words, it might influence the way they do business. Distributors and exhibitors are then highly concerned by the definition of such a system. Their requirements are quite different. Distributors are mainly preoccupied by the movie protection against piracy and the detailed audit trails of any unplanned projections. Exhibitors are more sensible to the system flexibility in order to adapt the projection rights to the success of the movie, the practical screen availability, etc. Both are requiring that this system does not modify the actual business rules between distributors and exhibitors.

The conditional access system of the invention solves these drawbacks by removing the need of a central entity which might also act as a gatekeeper. Specifically, this invention relates to a system for the delivery of digital rights and content decryption keys from rights owners to rights consumers without the need of a central entity. Keys and digital rights travel tt from the rights owner to the rights consumer through several intermediaries. The control of the system is distributed throughout all the actors of the system, each one controlling the system locally.

### SUMMARY OF THE INVENTION

In view of the above, there is a need for a conditional access system for the distribution and management of digital rights and keys in business-to-business applications which respects the current and future business rules and which is more flexible with respect to the actions allowed to each actor and to a fluctuation in the number of actors.

According to an aspect of the invention, there is provided a conditional access system for the distribution and management of digital rights and keys in business-to-business applications of a plurality of actors including rights owners and rights consumers, comprising decomposing the logical path between the rights owner and the rights consumer into a succession of point-to-point communications. Each communication takes place between actors or groups of actors, sharing information that allows identifying actors or groups of actors and establishing secure communications between these actors or groups of actors.

According to a preferred aspect of the invention stated in the preceding paragraph, the system further comprises matching the keys communication channels and digital rights communication channels with a network of business relations defining a network of trust between the different actors.

According to another aspect of the invention there is provided a conditional access system for the distribution and management of digital rights and keys in business-to-business applications of a plurality of actors including rights owners and rights consumers, comprising matching the keys communication channels and digital rights communication channels with a network of business relations defining a network of trust between the different actors.

According to a preferred aspect of the invention stated in the preceding paragraph, the system further comprises decomposing the logical path between the rights owner and the rights consumer into a succession of point-to-point communications between actors or groups of actors, and by sharing information that allows identifying actors or groups of actors and establishing secure communications between these actors or groups of actors.

The conditional access system of the invention for the distribution and management of digital rights and keys is adapted to be used in a digital cinema network comprising keys communication channels and digital rights communication channels.

According to a preferred aspect of the invention, the system further comprises implementing a trust infrastructure which defines the roles, responsibilities and authorizations of any of the plurality of actors.

According to a preferred aspect of the invention, the trust infrastructure is a hierarchical infrastructure.

According to a preferred aspect of the invention, the hierarchical infrastructure is a X.509-based PKI (Public Key Infrastructure).

According to a preferred aspect of the invention, the trust infrastructure is a decentralized infrastructure.

According to a preferred aspect of the invention, the decentralized infrastructure is a SPKI (Simple Public Key Infrastructure).

According to a preferred aspect of the invention, the actors are enabled to leave intact or modify the keys and the digital rights within the framework of the trust infrastructure.

According to a preferred aspect of the invention, constraints for each individual right can be further restricted or left intact, but not relaxed.

According to a preferred aspect of the invention, obligations acquired by accepting the digital rights document can be further expanded or left intact, but not reduced.

According to a preferred aspect of the invention, verification operations on keys and digital rights are performed by each actor.

According to a preferred aspect of the invention, the verification operation, when receiving keys, includes verifying the integrity and/or the origin and/or the authenticity of the keys.

According to a preferred aspect of the invention, the verification operation, when receiving a digital rights document, includes verifying the integrity of the digital rights document and/or its authenticity and/or its origin.

According to a preferred aspect of the invention, the verification operation includes using hashing functions to check the integrity of the digital rights document or keys, and to use public-key cryptography to verify its origin and/or authenticity.

According to a preferred aspect of the invention, RSA signatures are used to verify the origin and/or authenticity of the digital rights document and/or of the keys.

According to a preferred aspect of the invention, the keys and/or the digital rights are encrypted.

According to a preferred aspect of the invention, the keys and/or the digital rights are encrypted with an asymmetric cryptographic algorithm.

According to a preferred aspect of the invention, the keys and/or the digital rights are encrypted with RSA.

According to a preferred aspect of the invention, the rights owner encrypts the content keys using the rights consumer public key, thus guaranteeing only the rights consumer will be able to access the keys.

According to a preferred aspect of the invention, the communication is unidirectional or bi-directional, off-line or on-line.

According to a preferred aspect of the invention, the communication includes communicating audit data in addition to the digital rights and keys.

According to a preferred aspect of the invention, the communication includes separate communication channels for communicating the digital rights and the keys and the audit data.

According to a preferred aspect of the invention, the communication of the digital rights, the keys and the audit data is via Internet, PSTN or others.

According to a preferred aspect of the invention, the communication of the digital rights, the keys and the audit data is made by XML documents.

According to an aspect of the invention, a computer software for running a conditional access system for the distribution and management of digital rights and keys in a digital cinema network comprising keys communication channels and digital rights communication channels, comprises modules of the following types: distributor software module that will allow a distributor to define rights and obligations attached to a content; and theatre software or hardware module operating in a server, in a computer or in a specific device placed in a theatre that will receive and process the keys and rights and enable one or several projectors to make a projection.

According to a preferred version of the preceding aspect of the invention, the distributor software module is configured to provide the encryption of the content.

According to a preferred version of the preceding aspect, the invention further comprises an intermediary office software module that will allow the intermediary to receive rights and keys, to process them and send them to other actors of the system.

According to a preferred aspect of the invention in the preceding paragraph, processing in the intermediary office software module comprises rights restriction, obligation enlargement or key manipulations.

According to a preferred version of the preceding aspect of the invention, the software or hardware module is configured to send the movie keys to a decryption module logically attached to a projector, with an explicit or implicit single playout authorization, possibly with a time frame and/or a time stamp, if it has received the right to do it.

A distributor software module for use in a conditional access system for the distribution and management of digital rights and keys in a digital cinema network comprising keys communication channels and digital rights communication channels, comprising a software package that will allow a distributor to define rights and obligations attached to a content.

According to a preferred version of the preceding aspect of the invention, the distributor software module is configured to provide the encryption of the content.

An intermediary office software for use in a conditional access system for the distribution and management of digital rights and keys in a digital cinema network comprising keys communication channels and digital rights communication channels, comprising an intermediary office software package that will allow the intermediary to receive rights and keys, to process them and send them to other actors of the system.

According to a preferred version of the preceding aspect of the invention, processing in the intermediary office software module comprises rights restriction, obligation enlargement or key manipulations.

A software or hardware module for use in a conditional access system for the distribution and management of digital rights and keys in a digital cinema network comprising keys communication channels and digital rights communication channels, comprising a software or hardware package operating in a server, in a computer or in a specific device placed in a theatre that will receive and process the keys and rights and enable one or several projectors to make a projection.

According to a preferred version of the preceding aspect of the invention, the software or hardware module is configured to send the movie keys to a decryption module logically attached to a projector, with an explicit or implicit single playout authorization, possibly with a time frame and/or a time stamp, if it has received the right to do it.

A computer readable medium having stored thereon a computer software for running a conditional access system for the distribution and management of digital rights and keys in a digital cinema network comprising keys communication channels and digital rights communication channels, comprising modules of the following types:

distributor software module that will allow a distributor to define rights and obligations attached to a content; and

theatre software module operating in a server, in a computer or in a specific device placed in a theatre that will receive and process the keys and rights and enable one or several projectors to make a projection.

According to a preferred version of the preceding aspect, the invention further comprising intermediary office software module that will allow the intermediary to receive rights and keys, to process them and send them to other actors of the system.

A computer readable medium having stored thereon a distributor software module for use in a conditional access system for the distribution and management of digital rights and keys in a digital cinema network comprising keys communication channels and digital rights communication channels, comprising a software package that will allow a distributor to define rights and obligations attached to a content.

A computer readable medium having stored thereon an intermediary office software for use in a conditional access system for the distribution and management of digital rights and keys in a digital cinema network comprising keys communication channels and digital rights communication channels, comprising an intermediary office software package that will allow the intermediary to receive rights and keys, to process them and send them to other actors of the system.

A computer readable medium having stored thereon a software for use in a conditional access system for the distribution and management of digital rights and keys in a digital cinema network comprising keys communication channels and digital rights communication channels, comprising a software package operating in a server, in a computer or in a specific device placed in a theatre that will receive and process the keys and rights and enable one or several projectors to make a projection.

According to the preferred embodiments of the invention matching of the keys and digital rights communication channels with the network of business relations existing in the market where the system is implemented. These business relations define a network of trust between the different actors. A trust infrastructure implements these business relations and brings them to the knowledge of the system. This trust infrastructure actually defines the roles, responsibilities and authorizations of the different actors in the system. This infrastructure guarantees the security in the distribution of decryption keys and digital rights from rights owners down to rights consumers.

The matching between the distributed digital rights system and the network of business relationships is based on the decomposition of the logical path between the rights owner and the rights consumer into a succession of point-to-point communications. Each point-to-point communication takes place between at least two actors who know each other. Knowledge means that one of the actors is conscious of the existence of the other actor and knows a parameter or set of parameters that uniquely identifies the other actor and allows secure communications with it. This knowledge means the actors have some business relationships in the real world, which are implemented by the trust infrastructure in the system.

Management is performed locally and thus, any actor in the system can take decisions and initiatives provided they follow the business relations defined through the trust infrastructure. The locally-managed nature of the system provides a high degree of flexibility for each of the actors, precisely, because digital rights are managed locally. Each actor can, from a digital rights document it received, create new digital rights documents for other actors in the system, provided these operations follow the digital rights received by the actor and the existing business rules implemented by the trust infrastructure. Rights and keys then follow paths corresponding to the business relations that exist in the market.

Furthermore, the distributed digital rights system scales well precisely because the system is distributed. Whenever there is addition, suppression or modification of an actor in the system, only those with established relationships with it need to be notified. This mechanism allows the system to evolve into various topologies and sizes without any increase in complexity in the management of the system.

The security of the system relies on the trust infrastructure that brings the existing business relationships to the knowledge of the system. This trust infrastructure provides the necessary parameters to the system allowing the establishment of secure communications, mutual authentication and/or verification of message authenticity. Furthermore, it defines the roles of each actor and its authorizations. It can be an offline process with a manual entry of the parameters, a hierarchical trust infrastructure such as X.509-based PKI (Public Key Infrastructure) or a decentralized trust infrastructure such as SPKI (Simple Public Key Infrastructure).

In digital cinema, the system allows the distribution of movie decryption keys and projection rights from the studio or distributor to the decryption device through the different intermediaries existing in the distribution chain. It receives movie decryption keys from the encryption device, external to the system. On the projector side, it delivers the decryption keys to the decryption device with the right to use them at a specific moment in time or during a given time frame. The system also handles keys and rights related to a second kind of content: audit trails. Audit trails are logging information of the system relative to the usage or consumption of rights and management of the system. Audit trails can be managed taking two different approaches: whether as obligations to follow in order to execute a right, or as content upon which access rights are defined. The former is handled by the distributed digital rights system and by the obligations defined for each actor managing digital rights. The later can be seen as digital rights over a specific content, audit trails in this case, and as such, can be managed by the system directly.

A further understanding of the nature and advantages of the embodiments of the present invention may be realized by reference to the remaining portions of the specification and the drawings.

### BRIEF DESCRIPTION OF THE DRAWINGS

FIG. 1 shows the system architecture based on the business relationships between actors or the system users.

FIG. 2 shows how the communication path is decomposed into a succession of point-to-point communications.

FIG. 3 shows an illustration of a local pair of actors.

FIG. 4 shows the communication between a distributor and a theater in a digital cinema distribution network.

FIG. 5 shows an example of the communication between a distributor, an exhibitor chain, a theater and the projectors.

### DESCRIPTION OF THE SPECIFIC EMBODIMENTS

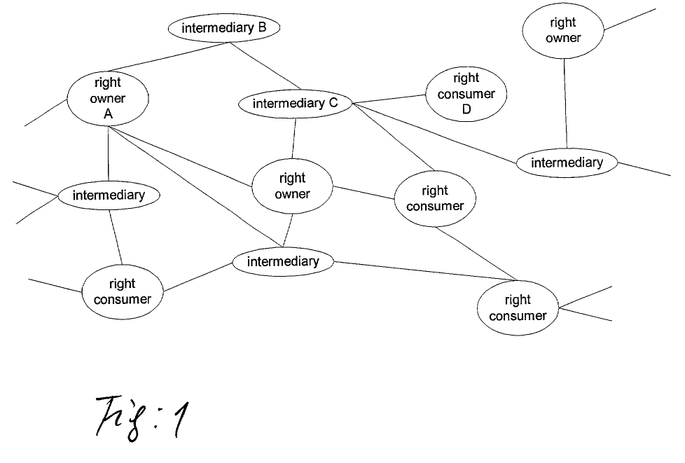

The architecture of the system is based on the business and trust relations existing between the users of the system. FIG. 1 represents an example of network of relationships between these users. Each node is an actor of the system and each link represents the existence of a business relationship between the actors, which at a system level, means the existence of a logical communication channel between them. In case an actor is merely a device, the term business relationship here means that an actor establishing a relationship with the device expects it to act according to the specification provided by the device manufacturer.

In this document, the term communication channel is used to refer to logical communication channels. The term actor refers to a logic entity. A physical entity can implement multiple actors or an actor can be spread between several physical entities.

The system design aims at mapping in the electronic world, a network of business relationships that form the rights distribution chain. Somehow, the system needs to know this network, and the precise nature of the relationships. This is the role of the trust infrastructure above the distributed digital rights system. This trust infrastructure defines, for each pair of actors, what are the rules governing their relationship. The topology, setup or management of this infrastructure may be conventional. This trust infrastructure could be in the form of a manual process initiated by each individual actor, or in the form of a more complex infrastructure based on certification and authorizations.

The system handles the secure communication of keys and usage rights from rights owners to rights consumers. Keys are a set of data needed by the decryption device to access the content. They are called decryption keys. Usage rights are a set of access rights, constraints and obligations that an actor shall respect in order to be allowed to access the content. For example, one can define the right to play a movie, with the constraint that the movie is to be played between two specific dates, or a maximum number of times. A constraint basically imposes some restrictions upon under which circumstances a right can be executed. An obligation, on the other hand, represents obligations the rights consumer agrees to comply with in order to execute a specific right. Rights are described in a digital rights document that, among others, identify the rights owner, the document issuer and subject, a description of the rights over some specific content, with the possibility of adding constraints and obligations. This document can also contain other data.

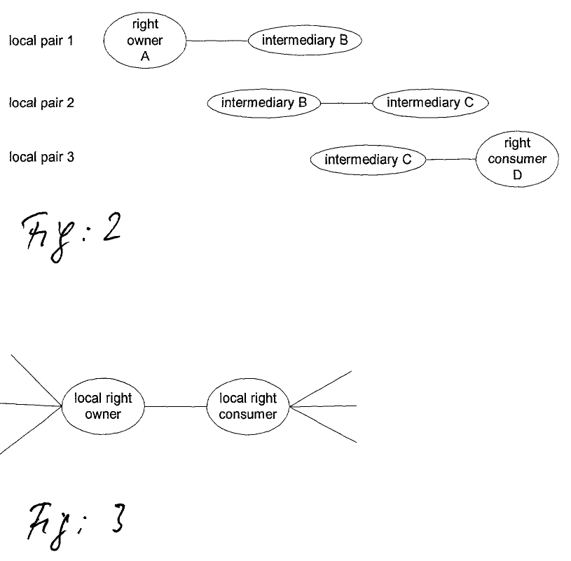

The communication of keys and digital rights documents from a rights owner to one or several rights consumers will use communication channels forming a path between the owner and the consumers. This communication can then be decomposed into a succession of point-to-point communications between at least two actors who know (note: know was already defined earlier in this document) each other. This knowledge means the actors are linked by some business relationship, which is implemented by the trust infrastructure. Two actors or groups of actors who know each other form a local pair. FIG. 2 shows a possible decomposition of a distribution chain from FIG. 1 into a succession of local pairs.

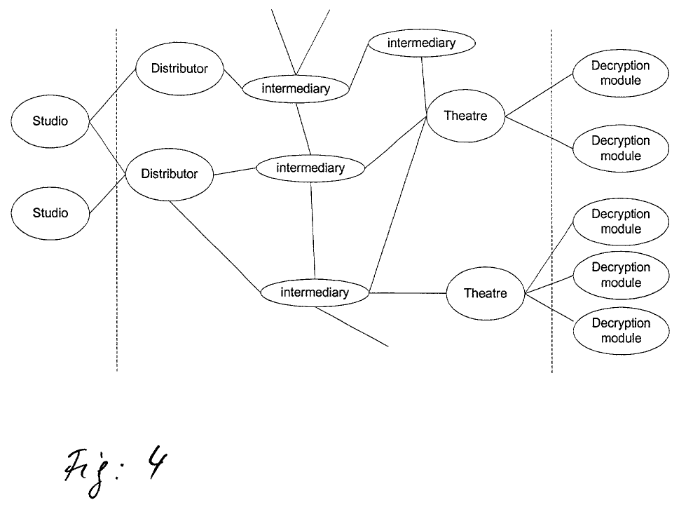

Each pair of actors can be seen as a conditional access system in which one actor is the rights owner and the others are the rights consumers, as shown in FIG. 3. The rights owner defines a set of rights for the given rights consumer. The local component of the system at the rights consumer will validate these rights and verify that the associated constraints and/or obligations are fulfilled.

A point-to-multipoint communication between one actor and several other actors is considered as being a set of individual communications between the actor and each of the other actors.

The information transferred through the system are keys and digital rights. In digital cinema for example, the content can be the movie, or audit data or trails sent back to the distributor.

Keys and digital rights documents might be sent independently or together from one actor to the other. The transmission of keys and digital rights documents between a rights owner and a rights consumer can follow different paths.

The preferred embodiment for the transmission of keys and rights are XML documents.

A rights owner can send keys and digital rights documents to a rights consumer he/she knows. This local communication has several characteristics to guarantee the security of the whole system During the transmission, at least, keys shall be protected in order to prevent unauthorized access by an eavesdropper. The preferred embodiment for the protection mechanism is encryption with asymmetric cryptographic algorithms such as RSA. The rights owner can encrypt the content keys using the rights consumer public key, thus guaranteeing only the rights consumer will be able to access the keys.

Depending on the security sensitiveness of the information exchanged between rights owner and consumer, the messages may need to provide confidentiality, non-repudiation and proofs of integrity, authenticity or origin. All these are well-known cryptographic techniques in the art.

### Actors

An actor in the system can receive and send keys and digital rights documents. The security of the system is guaranteed by verification operations performed by each actor. When receiving keys, the actor shall verify the integrity and/or the origin and/or the authenticity of the keys. When receiving a digital rights document, the actor shall verify the integrity of the digital rights document and/or its authenticity and/or its origin. The preferred embodiment for these verification mechanisms is to use hashing functions to check the integrity of a message, and to use public-key cryptography (RSA signatures for example) to verify its origin and/or authenticity.

An actor who wants to send keys and digital rights to another actor needs to provide the receiving actor with the required information so that these verification operations can be performed. This verifying information will be related to the trust infrastructure above the distributed digital rights system.

An intermediary, an actor receiving some digital rights documents and issuing new digital rights to other actors in the system, can create new digital rights based on an already existing one of which it is the subject. The new digital rights document must conform to the following rules. First, the new digital rights document can give the same set of rights that the intermediary received, or a new set of more limited rights and/or enlarged obligations. Then constraints, if any, for each individual right can be further restricted or left intact, but never relaxed. And last, obligations acquired by accepting the digital rights document, if any, can be further expanded or left intact, but never reduced. Following these rules the system guarantees that the digital rights as defined by the rights owner are respected throughout the whole distribution chain down to the rights consumer.

Content decryption keys are sent from one actor to another if and only if the sender knows that the receiver has some rights over the content. For this purpose the sender simply sends a digital rights document along with the keys, or the receiver presents a sequence of one or more digital rights proving the delegation of rights from the rights owner to the receiving actor.

The local behavior of the system is constrained by the roles and authorizations the actor has, as defined by the trust infrastructure, and the digital rights it has received as an element in the distribution chain. That system guarantees the above-mentioned constraints are not violated. Whoever commands the system locally, be it a human being or an automation application, can perform any action, from the creation of a new digital rights document to the addition of another actor in the system, provided these actions do not violate the abovementioned constraints.

### Application in Digital Cinema

The conditional access system of an embodiment of the invention has a direct application in the digital cinema market. The system enforces today's practice in film rental agreements that are continuously negotiated between distributors and exhibitors, with a balance between rights and obligations determined by the system users. While a classic conditional access system will simply prevent unauthorized access to the content, the conditional access system according to the embodiments of the invention encloses an enlarged set of advantages.

The conditional access system according to the embodiments of the invention meets the requirements of both distributors and exhibitors. It defines an architecture that processes movie projection rights in a similar way to what is done today. The balance between enforcement and audit, the path through which the rights are negotiated and sent are chosen by the actors of the market, like studios, distributors, intermediaries, theatres among others. Finally, the use of the system does not impose a central controlling entity to make the system work or to guarantee the system security.

This conditional access system offers a powerful rights management which is more than the basic respect of the film rental agreement. It allows the distributors and exhibitors to remotely negotiate projection rights at any time without having to send the encrypted movie or the movie keys again. This negotiation can be performed directly or through intermediaries.

The projection rights are wrapped in digital rights documents that are sent to theatres through a channel independent from the one used to send the encrypted movie. Digital rights documents can be modified at each stage, according to some rules, such that it combines the enforcement of the granted rights with the possibility to further restrict these rights. This improves the system flexibility and better matches its behavior to the current business usages.

The conditional access system is based on a modular platform. It is straightforward to replace a module by another in order to tune the system to the customer needs. This modularity and the fact that each actor has a local control of the system allow him to easily add or remove an intermediary or a theatre from the system.

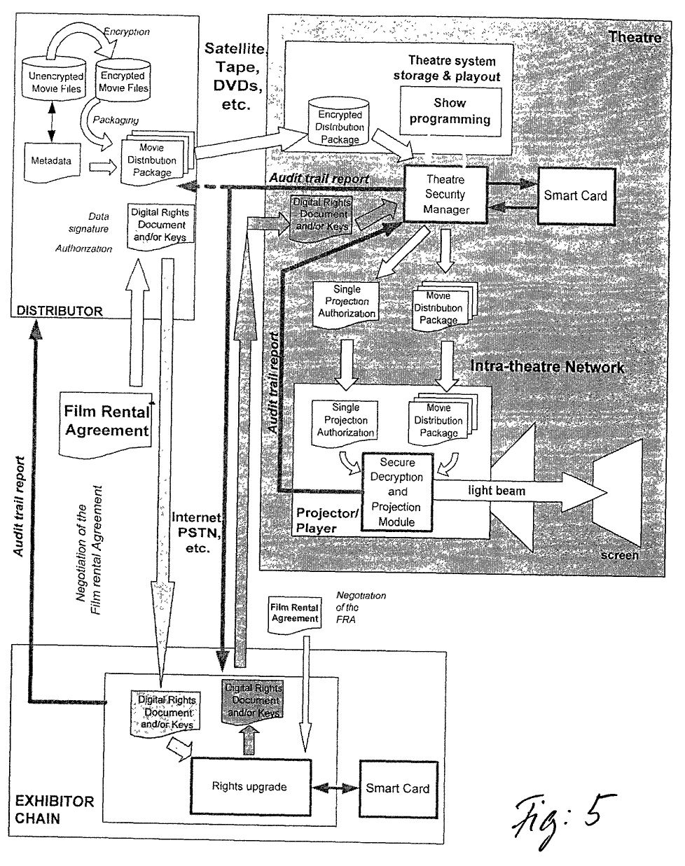

The following paragraphs describe an example on how the system can be used to implement an original key and rights management system for the digital cinema. FIG. 4 shows the architecture of a digital cinema distribution network. The system is mapped on this network between the two dotted lines. In this market, movies are distributed from distributors to theatres through various communication channels. The market is governed by specific business rules. A network of business agreement implements the trust between the different actors of the market: studio, distributors, intermediaries, theatres, etc. Keys and projection rights have to be distributed from the distributor to the projectors and other players in a secure way. Existing keys and rights distribution systems require the use of a central entity who knows the distributors and all the projectors that will potentially play a movie.

The embodiment of the invention in a conditional access system for the digital cinema defines a new original key and rights management system for this application. The system architecture is mapped on the current structure of the relationship between the different actors. Distributors, intermediaries and theatres are actors in the system. Studios, projectors and external actors are communicating with the system to provide inputs and use outputs of the system. The system mainly handles keys and digital rights related to two kinds of content: movies and audit trails. Audit trails are information related to the past and present status of the system, the behavior of the actors, the conditions and context of the accesses to the content. Audit trails can also be considered as obligations that need to be fulfilled. Information related to movies will generally travel from distributors to theatres, while audit trails generally will travel from the theatres to the distributors.

The system accepts keys, digital rights documents and information related to a movie as inputs from the studios and from the external actors. It can also receive keys, digital rights and information related to specific audit trails coming from the projectors or from external actors. The outputs are keys and digital rights documents related to audit trails in the system, or specific and limited rights for the projectors.

The system handles the distribution of movie-related keys and digital rights from the distributors to the theatres. Distributors are then rights owners and theatres are rights consumers for the movies. Keys are the movie decryption keys. For movies, rights are for example the right to play a title. Constraints are, for example, the beginning and ending dates of the authorization, or a maximum number of times the titles can be played. Other constraints could relate to play-out equipment characteristics such as the quality of the picture, or the security level of a projector. Obligations represent obligations the rights consumer must fulfill if it accepted the digital rights document. An obligation could be, for example, the obligation of sending audit trails to a given actor.

In a theatre, the system will control if the planned projections are in accordance with the digital rights received and with the business rules governing the relationship between distributor and exhibitor. If the projection is not authorized, the event may be securely logged for the possible insertion into future audit trails. When a projection is requested or some time before, the system will send the movie keys with, for example, an explicit or implicit single playout authorization, possibly with a time frame and/or a time stamp.

Audit trails can be handled by the system in a similar way. Each actor can generate audit trails and treat them as the target of digital rights, protected by keys and controlling access through digital rights. The system can handle the distribution of the audit trail access keys and digital rights, from the theatres up the distribution chain to the rights owner or distributor. The system described here is independent of the nature of the content and the precise rights, constraints and obligation; thus the system as presented here could also be used to handle the rights for audit trails content. In the case of digital cinema, the theater would become the rights owner while the distributor the rights consumer.

In the digital cinema application, a possible embodiment of the invention would be through a software having three different components:

A software running on a computer that will allow a distributor to define rights and obligations attached to a content. This software might also take in charge the encryption of the content.

A software running on a computer that will be placed in each intermediary office. This software will allow the intermediary to receive rights and keys, to process them (rights restriction, obligation enlargement or key manipulations) and to send them to other actors of the system.

A software or hardware module operating in a server, in a computer or in a specific device placed in a theatre that will receive and process the keys and rights. This component is called a theatre security manager. This component sends the movie keys to the decryption module logically attached to a projector, with an explicit or implicit single playout authorization, possibly with a time frame and/or a time stamp, if it has received the right to do it. The decryption module can be a software or a hardware module, implemented for example in the server, in the decoder or in the projector.

An example of a practical embodiment of the system is depicted on FIG. 5. A distributor is communicating with a theatre through an exhibitor chain owning this theatre. This exhibitor chain acts as an intermediary in the system.

At any time, the distributor can encrypt a movie, package it and send it to all or some of the theatres. At the same time, he will negotiate the film rental agreement with the exhibitor chain. When the negotiation concludes, the distributor encodes the Film Rental Agreement as rights and obligations in a digital rights document linked to the content keys. He sends then the keys and the digital rights document, together or separately to the exhibitor chain.

The exhibitor chain negotiates in turn with its theatres (or is already negotiating) concerning the rights he/she will grant to each theatre. When the negotiation is concluded, the exhibitor chain will modify the digital rights document so that each theatre receives a limited subset of the rights granted by the distributor with possibly larger obligations.

At each location, a smart card (or other secure device) is used to securely store parameters allowing to uniquely identify the different actors and to ensure the safety of the communications.

In the theatre, the rights and keys are stored in the theatre security manager. This manager communicates with the external parts of the system, more precisely with the system used to plan the projections and with the different decryption modules logically attached to each projector. It allows checking in advance if a projection planning is authorized or possible. At the time of the projection or some time before, it sends to the decryption module an implicit or explicit single projection authorization, possibly with a time frame and/or a time stamp, if it has the right to do it. Keys are then sent to the decryption module encrypted with the key of the decryption module.

It is to be understood that the above description is intended to be illustrative and not restrictive. Many embodiments will be apparent to those skilled in the art upon reviewing the above description. The scope of the invention should, therefore, be determined not as reference to the above description, but should instead be determined with reference to the appended claims along with the full scope of equivalence to which such claims are entitled.

What is claimed is:

1. Conditional access system for the distribution and management of digital rights and keys in business-to-business applications of a plurality of actors including rights owners and rights consumers, comprising:
decomposing the logical path between the rights owner and the rights consumer into a succession of point-to-point communications between actors or groups of actors, and
sharing information that allows identifying actors or groups of actors and establishing secure communications between these actors or groups of actors.

2. The system of claim 1, further comprising matching the keys communication channels and digital rights communication channels with a network of business relations defining a network of trust between the different actors.

3. The system of claim 1, further comprising implementing a trust infrastructure which defines the roles, responsibilities and authorizations of any of the plurality of actors.

4. The system of claim 3, wherein the trust infrastructure is a hierarchical infrastructure.

5. The system of claim 4, wherein the hierarchical infrastructure is a X.509-based PKI (Public Key Infrastructure).

6. The system of claim 3, wherein the trust infrastructure is a decentralized infrastructure.

7. The system of claim 6, wherein the decentralized infrastructure is a SPKI (Simple Public Key Infrastructure).

8. The system of claim 1, wherein the actors are enabled to leave intact or modify the keys and the digital rights within the framework of the trust infrastructure.

9. The system of claim 8, wherein constraints for each individual right can be further restricted or left intact, but not relaxed.

10. The system of claim 9, wherein obligations acquired by accepting the digital rights document can be further expanded or left intact, but not reduced.

11. The system of claim 1, wherein verification operations on keys and digital rights are performed by each actor.

12. The system of claim 11, wherein the verification operation, when receiving keys, includes verifying the integrity and/or the origin and/or the authenticity of the keys.

13. The system of claim 11, wherein the verification operation, when receiving a digital rights document, includes verifying the integrity of the digital rights document and/or its authenticity and/or its origin.

14. The system of claim 11, wherein the verification operation includes using hashing functions to check the integrity of the digital rights document or keys, and to use public-key cryptography to verify their origin and/or authenticity.

15. The system of claim 14, wherein RSA signatures are used to verify the origin and/or authenticity of the digital rights document and/or of the keys.

16. The system of claim 1, wherein the keys and/or the digital rights are encrypted.

17. The system of claim 16, wherein the keys and/or the digital rights are encrypted with an asymmetric cryptographic algorithm.

18. The system of claim 17, wherein the keys and/or the digital rights are encrypted with RSA.

19. The system of claim 16, wherein the rights owner encrypts the content keys using the rights consumer public key, thus guaranteeing only the rights consumer will be able to access the keys.

20. The system of claim 1, wherein the communication is unidirectional or bi-directional, off-line or on-line.

21. The system of claim 1, wherein the communication includes communicating audit data in addition to the digital rights and keys.

22. The system of claim 21, wherein the communication includes separate communication channels for communicating the digital rights and the keys and the audit data.

23. The system of claim 21, wherein the communication of the digital rights and/or the keys and/or the audit data is made by XML documents.

24. Conditional access system for the distribution and management of digital rights and keys in business-to-business applications of a plurality of actors including rights owners and rights consumers, comprising matching the keys communication channels and digital rights communication channels with a network of business relations defining a network of trust between the different actors.

25. The system of claim 24, further comprising decomposing the logical path between the rights owner and the rights consumer into a succession of point-to-point communications between actors or groups of actors, and by sharing information that allows identifying actors or groups of actors and establishing secure communications between these actors or groups of actors.

26. The system of claim 24, further comprising implementing a trust infrastructure which defines the roles, responsibilities and authorizations of any of the plurality of actors.

27. The system of claim 26, wherein the trust infrastructure is a hierarchical infrastructure.

28. The system of claim 27, wherein the hierarchical infrastructure is a X.509-based PKI (Public Key Infrastructure).

29. The system of claim 26, wherein the trust infrastructure is a decentralized infrastructure.

30. The system of claim 29, wherein the decentralized infrastructure is a SPKI (Simple Public Key Infrastructure).

31. The system of claim 24, wherein the actors are enabled to leave intact or modify the keys and the digital rights within the framework of the trust infrastructure.

32. The system of claim 31, wherein constraints for each individual right can be further restricted or left intact, but not relaxed.

33. The system of claim 31, wherein obligations acquired by accepting the digital rights document can be further expanded or left intact, but not reduced.

34. The system of claim 24, wherein verification operations on keys and digital rights are performed by each actor.

35. The system of claim 34, wherein the verification operation, when receiving keys, includes verifying the integrity and/or the origin and/or the authenticity of the keys.

36. The system of claim 34, wherein the verification operation, when receiving a digital rights document, includes verifying the integrity of the digital rights document and/or its authenticity and/or its origin.

37. The system of claim 34, wherein the verification operation includes using hashing functions to check the integrity of the digital rights document or keys, and to use public-key cryptography to verify their origin and/or authenticity.

38. The system of claim 37, wherein RSA signatures are used to verify the origin and/or authenticity of the digital rights document and/or of the keys.

39. The system of claim 24, wherein the keys and/or the digital rights are encrypted.

40. The system of claim 39, wherein the keys and/or the digital rights are encrypted with an asymmetric cryptographic algorithm.

41. The system of claim 40, wherein the keys and/or the digital rights are encrypted with RSA.

42. The system of claim 24, wherein the rights owner encrypts the content keys using the rights consumer public key, thus guaranteeing only the rights consumer will be able to access the keys.

43. The system of claim 24, wherein the communication is unidirectional or bi-directional, off-line or on-line.

44. The system of claim 24, wherein the communication includes communicating audit data in addition to the digital rights and keys.

45. The system of claim 44, wherein the communication includes separate communication channels for communicating the digital rights and the keys and the audit data.

46. The system of claim 44, wherein the communication of the digital rights and/or the keys and/or the audit data is made by XML documents.

47. Conditional access system for the distribution and management of digital rights and keys in a digital cinema network comprising keys communication channels and digital rights communication channels, the system comprising decomposing the logical path between the rights owner and the rights consumer into a succession of point-to-point communications between actors or groups of actors, and by sharing information that allows identifying actors or groups of actors and establishing secure communications between these actors or groups of actors.

48. The system of claim 47, further comprising matching the keys communication channels and digital rights communication channels with a network of business relations defining a network of trust between the different actors.

49. The system of claim 47, further comprising implementing a trust infrastructure which defines the roles, responsibilities and authorizations of any of the plurality of actors.

50. The system of claim 49, wherein the trust infrastructure is a hierarchical infrastructure.

51. The system of claim 50, wherein the hierarchical infrastructure is a X.509-based PKI (Public Key Infrastructure).

52. The system of claim 49, wherein the trust infrastructure is a decentralized infrastructure.

53. The system of claim 52, wherein the decentralized infrastructure is a SPKI (Simple Public Key Infrastructure).

54. The system of claim 47, wherein the actors are enabled to leave intact or modify the keys and the digital rights within the framework of the trust infrastructure.

55. The system of claim 54, wherein constraints for each individual right can be further restricted or left intact, but not relaxed.

56. The system of claim 54, wherein obligations acquired by accepting the digital rights document can be further expanded or left intact, but not reduced.

57. The system of claim 47, wherein verification operations on keys and digital rights are performed by each actor.

58. The system of claim 57, wherein the verification operation, when receiving keys, includes verifying the integrity and/or the origin and/or the authenticity of the keys.

59. The system of claim 57, wherein the verification operation, when receiving a digital rights document, includes verifying the integrity of the digital rights document and/or its authenticity and/or its origin.

60. The system of claim 57, wherein the verification operation includes using hashing functions to check the integrity of the digital rights document or keys, and to use public-key cryptography to verify their origin and/or authenticity.

61. The system of claim 60, wherein RSA signatures are used to verify the origin and/or authenticity of the digital rights document and/or of the keys.

62. The system of claim 47, wherein the keys and/or the digital rights are encrypted.

63. The system of claim 62, wherein the keys and/or the digital rights are encrypted with an asymmetric cryptographic algorithm.

64. The system of claim 63, wherein the keys and/or the digital rights are encrypted with RSA.

65. The system of claim 47, wherein the rights owner encrypts the content keys using the rights consumer public key, thus guaranteeing only the rights consumer will be able to access the keys.

66. The system of claim 47, wherein the communication is unidirectional or bi-directional, off-line or on-line.

67. The system of claim 47, wherein the communication includes communicating audit data in addition to the digital rights and keys.

68. The system of claim 67, wherein the communication includes separate communication channels for communicating the digital rights and the keys and the audit data.

69. The system of claim 67, wherein the communication of the digital rights and/or the keys and/or the audit data is made by XML documents.

70. Conditional access system for the distribution and management of digital rights and keys in a digital cinema network comprising keys communication channels and digital rights communication channels, the system matching keys communication channels and digital rights communication channels with a network of business relations defining a network of trust between the different actors.

71. The system of claim 70, further comprising decomposing the logical path between the rights owner and the rights consumer into a succession of point-to-point communications between actors or groups of actors, and by sharing information that allows identifying actors or groups of actors and establishing secure communications between these actors or groups of actors.

72. The system of claim 70, further comprising implementing a trust infrastructure which defines the roles, responsibilities and authorizations of any of the plurality of actors.

73. The system of claim 72, wherein the trust infrastructure is a hierarchical infrastructure.

74. The system of claim 73, wherein the hierarchical infrastructure is a X.509-based PKI (Public Key Infrastructure).

75. The system of claim 72, wherein the trust infrastructure is a decentralized infrastructure.

76. The system of claim 75, wherein the decentralized infrastructure is a SPKI (Simple Public Key Infrastructure).

77. The system of claim 70, wherein the actors are enabled to leave intact or modify the keys and the digital rights within the framework of the trust infrastructure.

78. The system of claim 77, wherein constraints for each individual right can be further restricted or left intact, but not relaxed.

79. The system of claim 77, wherein obligations acquired by accepting the digital rights document can be further expanded or left intact, but not reduced.

80. The system of claim 70, wherein verification operations on keys and digital rights are performed by each actor.

81. The system of claim 80, wherein the verification operation, when receiving keys, includes verifying the integrity and/or the origin and/or the authenticity of the keys.

82. The system of claim 80, wherein the verification operation, when receiving a digital rights document, includes verifying the integrity of the digital rights document and/or its authenticity and/or its origin.

83. The system of claim 80, wherein the verification operation includes using hashing functions to check the integrity of the digital rights document or keys, and to use public-key cryptography to verify their origin and/or authenticity.

84. The system of claim 83, wherein RSA signatures are used to verify the origin and/or authenticity of the digital rights document and/or of the keys.

85. The system of claim 70, wherein the keys and/or the digital rights are encrypted.

86. The system of claim 85, wherein the keys and/or the digital rights are encrypted with an asymmetric cryptographic algorithm.

87. The system of claim 86, wherein the keys and/or the digital rights are encrypted with RSA.

88. The system of claim 70, wherein the rights owner encrypts the content keys using the rights consumer public key, thus guaranteeing only the rights consumer will be able to access the keys.

89. The system of claim 70, wherein the communication is unidirectional or bi-directional, off-line or on-line.

90. The system of claim 70, wherein the communication includes communicating audit data in addition to the digital rights and keys.

91. The system of claim 90, wherein the communication includes separate communication channels for communicating the digital rights and the keys and the audit data.

92. The system of claim 90, wherein the communication of the digital rights and/or the keys and/or the audit data is made by XML documents.

93. Computer software and/or hardware product for running a conditional access system for the distribution and management of digital rights and keys in a digital cinema network comprising keys communication channels and digital rights communication channels, the computer software and/or hardware modules comprising modules of the following types:
distributor software module that will allow a distributor to define rights and obligations attached to a content; and
theatre software or hardware module operating in a server, in a computer or in a specific device placed in a theatre that will receive and process the keys and rights and enable one or several projectors to make a projection.

94. The computer software and/or hardware product of claim 93, wherein the distributor software module is configured to provide the encryption of the content.

95. The computer software and/or hardware product of claim 93, further comprising an intermediary office software module that will allow the intermediary to receive rights and keys, to process them and send them to other actors of the system;

96. The computer software and/or hardware product of claim 95, wherein the processing in the intermediary office software module comprises rights restriction, obligation enlargement or key manipulations.

97. The computer software and/or hardware product of claim 93, wherein the software or hardware module is configured to send the movie keys to a decryption module logically attached to a projector, with an explicit or implicit single playout authorization, possibly with a time frame and/or a time stamp, if it has received the right to do it.

98. A distributor software module for use in a conditional access system for the distribution and management of digital rights and keys in a digital cinema network comprising keys communication channels and digital rights communication channels, comprising a software package that will allow a distributor to define rights and obligations attached to a content.

99. The computer software of claim 97, wherein the distributor software module is configured to provide the encryption of the content.

100. An intermediary office software for use in a conditional access system for the distribution and management of digital rights and keys in a digital cinema network comprising keys communication channels and digital rights communication channels, comprising an intermediary office software package that will allow the intermediary to receive rights and keys, to process them and send them to other actors of the system.

101. The computer software of claim 100, wherein the processing in the intermediary office software module comprises rights restriction, obligation enlargement or key manipulations.

102. A software or hardware module for use in a conditional access system for the distribution and management of digital rights and keys in a digital cinema network comprising keys communication channels and digital rights communication channels, comprising a software or hardware package operating in a server, in a computer or in a specific device placed in a theatre that will receive and process the keys and rights and enable one or several projectors to make a projection.

103. The software or hardware module of claim 102, wherein the software or hardware module is configured to send the movie keys to a decryption module logically attached to a projector, with an explicit or implicit single playout authorization, possibly with a time frame and/or a time stamp, if it has received the right to do it.

104. A computer readable medium having stored thereon a computer software for running a conditional access system for the distribution and management of digital rights and keys in a digital cinema network comprising keys communication channels and digital rights communication channels, comprising modules of the following types:
distributor software module that will allow a distributor to define rights and obligations attached to a content; and
theatre software module operating in a server, in a computer or in a specific device placed in a theatre that will receive and process the keys and rights and enable one or several projectors to make a projection.

105. A computer readable medium of claim 104, further comprising intermediary office software module that will allow the intermediary to receive rights and keys, to process them and send them to other actors of the system.

106. A computer readable medium having stored thereon a distributor software module for use in a conditional access system for the distribution and management of digital rights and keys in a digital cinema network comprising keys communication channels and digital rights communication channels, comprising a software package that will allow a distributor to define rights and obligations attached to a content.

107. A computer readable medium having stored thereon an intermediary office software for use in a conditional access system for the distribution and management of digital rights and keys in a digital cinema network comprising keys communication channels and digital rights communication channels, comprising an intermediary office software package that will allow the intermediary to receive rights and keys, to process them and send them to other actors of the system.

108. A computer readable medium having stored thereon a software for use in a conditional access system for the distribution and management of digital rights and keys in a digital cinema network comprising keys communication channels and digital rights communication channels, comprising a software package operating in a server, in a computer or in a specific device placed in a theatre that will receive and process the keys and rights and enable one or several projectors to make a projection.
